(19) United States
(12) Patent Application Publication
(10) Pub. No.: US 2009/0060163 A1
(43) Pub. Date: Mar. 5, 2009

(54) Call Establishment in Call Centers Having Heterogeneous Terminals

(75) Inventors: George William Erhart, Loveland, CO (US); Valentine C. Matula, Granville, OH (US); David Joseph Skiba, Golden, CO (US)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/850,653

(22) Filed: Sep. 5, 2007

(51) Int. Cl. H04M 7/00

(52) U.S. Cl. 379/219

(57) ABSTRACT

A method of establishing calls with call centers that have heterogeneous hardware and software is disclosed. In particular, the data processing system for establishing a call selects one or more terminals for call based on the set of capabilities of the respective terminals and on the quality-of-service parameters that characterize the telecommunications channels connecting the terminals.

The present invention relates to telecommunications in general, and, more particularly, to call routing in call centers.

### BACKGROUND OF THE INVENTION

Telecommunications call centers are common for handling large numbers of incoming calls for account management and tech support and for handling large numbers of outgoing calls for telephone sales. When call centers grow, however, there can be problems integrating new equipment because the new equipment can have different characteristics than the old equipment. Furthermore, as technology progresses the equipment that customers have can become mismatched with the equipment in the call center. Therefore, the need exists for a solution to this problem.

### SUMMARY OF THE INVENTION

The present invention enables the establishment of calls with call centers that have heterogeneous hardware and software without some of the costs and disadvantages for doing so in the prior art. In particular, the data processing system for establishing a call selects one or more terminals for call based on the set of capabilities of the respective terminals and on the quality-of-service parameters that characterize the telecommunications channels connecting the terminals.

The illustrative embodiment comprises:

establishing a call at a data processing system between a first telecommunications terminal and exactly one of:
(i) a second telecommunications terminal, and
(ii) a third telecommunications terminal;

wherein the first telecommunications terminal is connected to the data processing system via a first telecommunications channel that is characterized by a first set of quality-of-service parameters;

wherein the second telecommunications terminal is connected to the data processing system via a second telecommunications channel that is characterized by a second set of quality-of-service parameters;

wherein the third telecommunications terminal is connected to the data processing system via a third telecommunications channel that is characterized by a third set of quality-of-service parameters; and

wherein establishing the call comprises: deciding which of the second telecommunications terminal and the third telecommunications terminal to connect to the first telecommunications terminal based, at least in part, on the first set of quality-of-service parameters, the second set of quality-of-service parameters, and the third set of quality-of-service parameters.

### BRIEF DESCRIPTION OF THE DRAWINGS

FIG. 1 depicts telecommunications system 100 in accordance with the illustrative embodiment of the present invention.

FIG. 2 depicts a flowchart of the salient tasks associated with the operation of the illustrative embodiment of the present invention.

FIG. 3 depicts a flowchart of the salient tasks associated with the task 202, as described above.

### DETAILED DESCRIPTION

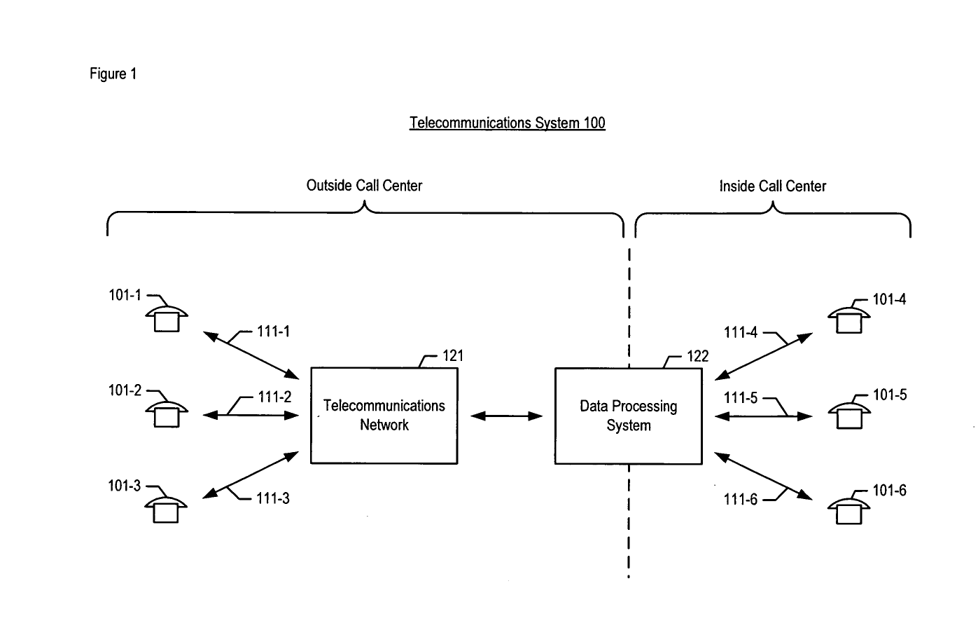

FIG. 1 depicts telecommunications system 100 in accordance with the illustrative embodiment of the present invention. System 100 comprises telecommunications terminals 101-1 through 101-6, telecommunications channels 111-1 through 111-6, telecommunications network 121, and data processing system 122, interconnected as shown.

In accordance with the illustrative embodiment, telecommunications terminals 101-1 through 101-3, telecommunications channels 111-1 through 111-3, and telecommunications network 121 are outside the scope of a call center. In contrast, telecommunications terminals 101-4 through 101-6, telecommunications channels 111-4 through 111-6, and data processing system 122 are inside the scope of the call center.

Although the illustrative embodiment comprises six (6) telecommunications terminals, it will be clear to those skilled in the art, after reading this disclosure, how to make and use alternative embodiments of the present invention that comprises any number of telecommunications terminals. Although the illustrative embodiment comprises three telecommunications terminals outside of the call center, it will be clear to those skilled in the art, after reading this disclosure, how to make and use alternative embodiments of the present invention that comprise any number of telecommunications terminals outside of the call center. Although the illustrative embodiment comprises three telecommunications terminals inside of the call center, it will be clear to those skilled in the art, after reading this disclosure, how to make and use alternative embodiments of the present invention that comprises any number of telecommunications terminals inside of the call center.

Each of telecommunications terminals 101-1 through 101-6 is capable of providing a telecommunications interface to a user through a set of terminal capabilities. For the purposes of this specification, a set of terminal capabilities comprises:
i. audio at one or more qualities, or
ii. video at one or more quantities, or
iii. haptics at one or more qualities, or
iv. service by one or more protocol services (e.g., POP3, HTTP, etc.), or
v. any combination of i, ii, and iii.
   In accordance with the illustrative embodiment, at least two of telecommunications terminals 101-1 through 101-6 are heterogeneous based on their terminal capabilities. It will be clear to those skilled in the art how to make and use each of telecommunications terminals 101-1 through 101-6.

Each of telecommunications channels 111-1 through 111-6 is characterized by a set of quality-of-service parameters. For the purposes of this specification, a set of quality-of-service parameters comprises:
i. a bandwidth parameter (which includes its time-derivatives), or
ii. a latency parameter (which includes its time-derivatives such as jitter), or
iii. an error-rate parameter (which includes its time-derivatives), or
iv. any combination of i, ii, and iii.
   In accordance with the illustrative embodiment, at least two of telecommunications channels 111-1 through 111-6 are heterogenous based on their set of quality-of-service parameters. It will be clear to those skilled in the art how to make and use each of telecommunications channels 111-1 through 111-6.

Telecommunications network 121 provides the connectivity between telecommunications terminals 101-1 through 101-3 and data processing system 122. Telecommunications network 121 can comprise:
i. the Public Switched Telephone Network, or
ii. the Internet, or
iii. one or more wireline networks, or
iv. one or more wireless networks, or
v. any combination of i, ii, iii, and iv.
   It will be clear to those skilled in the art, how to make and use telecommunications network 121.

Data processing system 122 is a combination of hardware and software that is capable of performing the functionality described below and in the accompanying figures. In general, data processing system 122 establishes a call between two or more of telecommunications terminals 101-1 through 101-6 based on:
i. the capabilities of the respective terminals, or
ii. the set of quality-of-service parameters associated with the telecommunications channel that connects the respective terminals, or
iii. both i and ii.

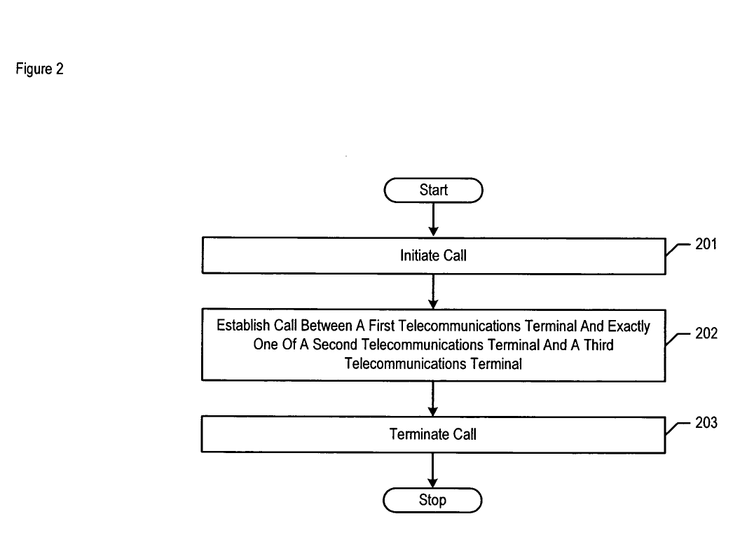

FIG. 2 depicts a flowchart of the salient tasks associated with the operation of the illustrative embodiment of the present invention.

At task 201, a call is initiated by telecommunications terminal 101-1 in well-known fashion to an address (e.g., telephone number, IP address, Skype address, etc.) associated with data processing system 122. It will be clear to those skilled in the art, after reading this specification, how to make and use alternative embodiments of the present invention in which the call is initiated by data processing system 122 itself or by any of telecommunications terminals 101-2 through 101-6.

At task 202, data processing system 122 establishes the call between telecommunications terminal 101-1 and exactly one of telecommunications terminals 101-4 and 101-5. In accordance with the illustrative embodiment, the call can also be established with one or more of telecommunications terminals 101-2, 101-3, and 101-6, but only with exactly one of telecommunications terminals 101-4 and 101-5. The details of task 202 are described below and in the accompanying figures. It will be clear to those skilled in the art, after reading this disclosure, how to make and use alternative embodiments of the present invention in which the call is established by data processing system 122 between any two or more of telecommunications terminals 101-1 through 101-6.

At task 203, the call is terminated in well-known fashion by either data processing system 122 or by any of the telecommunications terminals associated with the call.

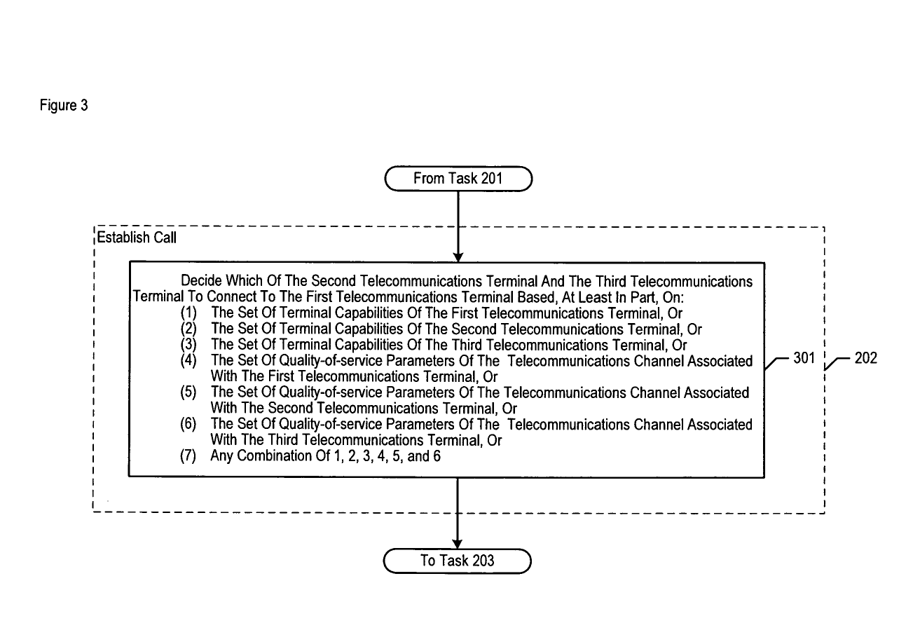

FIG. 3 depicts a flowchart of the salient tasks associated with the task 202, as described above.

At task 301, data processing system 122 decides which of telecommunications terminals 101-4 and 101-5 to establish the call with based, at least in part, on:
i. the set of terminal capabilities of telecommunications terminal 101-1, or
ii. the set of terminal capabilities of telecommunications terminal 101-4, or
iii. the set of terminal capabilities of telecommunications terminal 101-5, or
iv. the set of quality-of-service parameters of telecommunications channel 111-1, or
v. the set of quality-of-service parameters of telecommunications channel 111-4, or
vi. the set of quality-of-service parameters of telecommunications channel 111-5, or
vii. any combination of i, ii, iii, iv, v, and vi.

In accordance with the illustrative embodiment, data processing system 122 tries to match the capabilities of the telecommunications terminals and the quality-of-service parameters of their respective telecommunications channels so as to not waste resources.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
establishing a call at a data processing system between a first telecommunications terminal and exactly one of:
(i) a second telecommunications terminal, and
(ii) a third telecommunications terminal;
wherein the first telecommunications terminal is connected to the data processing system via a first telecommunications channel that is characterized by a first set of quality-of-service parameters;
wherein the second telecommunications terminal is connected to the data processing system via a second telecommunications channel that is characterized by a second set of quality-of-service parameters;
wherein the third telecommunications terminal is connected to the data processing system via a third telecommunications channel that is characterized by a third set of quality-of-service parameters; and
wherein establishing the call comprises: deciding which of the second telecommunications terminal and the third telecommunications terminal to connect to the first telecommunications terminal based, at least in part, on the first set of quality-of-service parameters, the second set of quality-of-service parameters, and the third set of quality-of-service parameters.

2. The method of claim 1 wherein the call is initiated by the first telecommunications terminal.

3. The method of claim 1 wherein the call is initiated by the data processing system.

4. The method of claim 1 wherein the first telecommunications terminal is characterized by a first set of terminal capabilities;
wherein the second telecommunications terminal is characterized by a second set of terminal capabilities; and
wherein the third telecommunications terminal is characterized by a third set of terminal capabilities; and
wherein the decision to route to exactly one of the second telecommunications terminal and the third telecommunications terminal is based, at least in part, on the first set of terminal capabilities, the second set of terminal capabilities, and the third set of terminal capabilities.

5. The method of claim 4 wherein the first set of terminal capabilities comprises a first protocol service.

6. The method of claim 1 wherein the first set of quality-of-service parameters comprises a first bandwidth parameter;
wherein the second set of quality-of-service parameters comprises a second bandwidth parameter;
wherein the third set of quality-of-service parameters comprises a third bandwidth parameter; and
wherein establishing the call comprises: deciding which of the second telecommunications terminal and the third telecommunications terminal to connect to the first telecommunications terminal based, at least in part, on the first bandwidth parameter, the second bandwidth parameter, and the third bandwidth parameter.

7. The method of claim 1 wherein the first set of quality-of-service parameters comprises a first latency parameter;
wherein the second set of quality-of-service parameters comprises a second latency parameter;
wherein the third set of quality-of-service parameters comprises a third latency parameter; and
wherein establishing the call comprises: deciding which of the second telecommunications terminal and the third telecommunications terminal to connect to the first telecommunications terminal based, at least in part, on the first latency parameter, the second latency parameter, and the third latency parameter.

8. The method of claim 1 wherein the first set of quality-of-service parameters comprises a first error-rate parameter;
wherein the second set of quality-of-service parameters comprises a second error-rate parameter;
wherein the third set of quality-of-service parameters comprises a third error-rate parameter; and
wherein establishing the call comprises: deciding which of the second telecommunications terminal and the third telecommunications terminal to connect to the first telecommunications terminal based, at least in part, at least in part, on the first error-rate parameter, the second error-rate parameter, and the third error-rate parameter.

9. A method comprising:
establishing a call at a data processing system between a first telecommunications terminal and exactly one of:
(i) a second telecommunications terminal, and
(ii) a third telecommunications terminal;
wherein the first telecommunications terminal is characterized by a first set of terminal capabilities;
wherein the second telecommunications terminal is characterized by a second set of terminal capabilities;
wherein the third telecommunications terminal is characterized by a third set of terminal capabilities; and
wherein establishing the call comprises: deciding which of the second telecommunications terminal and the third telecommunications terminal to connect to the first telecommunications terminal based, at least in part, on the first set of terminal capabilities, the second set of terminal capabilities, and the third set of terminal capabilities.

10. The method of claim 9 wherein the call is initiated by the first telecommunications terminal.

11. The method of claim 9 wherein the call is initiated by the data processing system.

12. The method of claim 9 wherein the first set of terminal capabilities comprises a first protocol service.

13. The method of claim 9 wherein the first telecommunications terminal is connected to the data processing system via a first telecommunications channel that is characterized by a first set of quality-of-service parameters;
wherein the second telecommunications terminal is connected to the data processing system via a second telecommunications channel that is characterized by a second set of quality-of-service parameters;
wherein the third telecommunications terminal is connected to the data processing system via a third telecommunications channel that is characterized by a third set of quality-of-service parameters; and
wherein establishing the call comprises: deciding which of the second telecommunications terminal and the third telecommunications terminal to connect to the first telecommunications terminal based, at least in part, on the first set of quality-of-service parameters, the second set of quality-of-service parameters, and the third set of quality-of-service parameters.

14. The method of claim 13 wherein the first set of quality-of-service parameters comprises a first bandwidth parameter;
wherein the second set of quality-of-service parameters comprises a second bandwidth parameter;
wherein the third set of quality-of-service parameters comprises a third bandwidth parameter; and
wherein the decision to route to exactly one of the second telecommunications terminal and the third telecommunications terminal is based, at least in part, on the first bandwidth parameter, the second bandwidth parameter, and the third bandwidth parameter.

15. The method of claim 13 wherein the first set of quality-of-service parameters comprises a first latency parameter;
wherein the second set of quality-of-service parameters comprises a second latency parameter;
wherein the third set of quality-of-service parameters comprises a third latency parameter; and
wherein the decision to route to exactly one of the second telecommunications terminal and the third telecommunications terminal is based, at least in part, on the first latency parameter, the second latency parameter, and the third latency parameter.

16. The method of claim 13 wherein the first set of quality-of-service parameters comprises a first error-rate parameter;
wherein the second set of quality-of-service parameters comprises a second error-rate parameter;
wherein the third set of quality-of-service parameters comprises a third error-rate parameter; and
wherein the decision to route to exactly one of the second telecommunications terminal and the third telecommunications terminal is based, at least in part, on the first error-rate parameter, the second error-rate parameter, and the third error-rate parameter.
